(19) United States
(12) Patent Application Publication
(10) Pub. No.: US 2025/0235833 A1
(43) Pub. Date: Jul. 24, 2025

(54) APPARATUS AND METHOD FOR GENERATING NANOBUBBLE-LIQUID SUSPENSION

(71) Applicant: Neelkanth NIRMALKAR, Ropar (IN)

(72) Inventors: Neelkanth NIRMALKAR, Ropar (IN); Mohit TRIVEDI, Ropar (IN); Nilanjan DUTTA, Ropar (IN); Harsh SHARMA, Ropar (IN)

(21) Appl. No.: 18/415,700

(22) Filed: Jan. 18, 2024

(51) Int. Cl. B01F 23/70; B01F 23/232; B01F 23/2375; F25B 21/02

(52) U.S. Cl. CPC B01F 23/711; B01F 23/232; B01F 23/2375; B01F 23/702; B01F 2215/0472; F25B 21/02; F25B 2321/0252

(57) ABSTRACT

An easy and effective system and method for generating a nanobubble liquid suspension through thermal shock mixing, in which two streams of gas-saturated liquid come into contact at different temperatures, and nanobubble generation is accomplished due to the solubility difference of gases in the streams, are disclosed. The apparatus includes a pair of flow channels to allow two gas-saturated liquid streams to pass through it parallelly. Each flow channel is configured with a plurality of conducting metallic fins throughout its length and parallel to the flow of the gas-saturated liquid flowing through the flow channels. A thermoelectric Peltier-element module thermally heats or cools the metallic fins to generate a heated liquid stream and a cooled liquid stream, that mix together to form nanobubbles. This system is thermally closed, resulting in negligible heat loss into the environment and making the apparatus/system thermally efficient.

### FIELD OF INVENTION

The present invention relates to the field of nanobubble technology. Particularly, the present invention relates to a method for the generation of nanobubbles (or ultrafine bubbles) in liquids and an apparatus thereof. More particularly, the present invention relates to a method of generating nanobubbles in a liquid by creating thermal gas solubility modulation using a Thermometric Peltier-element (TPE)-based apparatus.

### BACKGROUND OF THE INVENTION

Nanobubbles having a diameter of less than 1000 nm have been studied widely due to their extraordinary longevity in the liquid, negative surface charge, higher surface-to-volume ratio, etc. In recent years, the application of nanobubbles has been diversified into various fields and industries due to their distinct size and unique properties. Nanobubbles are effectively utilized in various applications in medicine, industry, agriculture, etc., for instance, in wastewater treatment, cleaning of surfaces, flotation, disinfection, aquaponics, and plant growth, to name a few.

Commercially available nanobubble generators use various methodologies to produce nanobubbles, such as hydrodynamic cavitation, acoustic cavitation, pressurized dissolution methods, etc. These generators, however, are very large, have high energy consumption, and are complex in design.

The U.S. Pat. No. 10,293,312 B2, for example, describes an apparatus for generating nanobubbles for use with fluid dispensing fittings. The apparatus includes a longitudinal shaft having a first end portion, a body, and a second end portion, wherein the body comprises airfoil-shaped projecting members arranged circumferentially on the outer circumferential surface of the body. Due to this design, the formation of nanobubbles is energy-inefficient, and the flow rate of the liquid is significantly reduced.

Further, the U.S. Pat. No. 10,814,290 B2 discloses a nanobubble generator comprising a treatment portion that includes at least two sequential shear surface planes separated by cavitation spaces. The prior art used circular discs with notch cuts in the flow passage, with some distance between the two disks, thus slowing down the flow rate of the liquid and resulting in low efficiency of the generator.

Thus, known methods for the generation of nanobubbles provide a solution to generate nanobubbles in liquids with various techniques such as cavitation, pressurized dissolution, etc. In most of the known methods, generation techniques are complex, expensive, and inefficient in terms of factors such as energy consumption, floor space requirements, complexity of process, cleaning of assemblies, etc. In some existing methods, a continuous generation of nanobubbles may be achieved, but with less concentration, while some methods have limitations in terms of the volume of nanobubble suspension preparation. Therefore, an efficient, simple, and inexpensive method for the continuous generation of nanobubbles is required.

Other objectives and advantages of the present invention will become apparent from the following description taken in connection with the accompanying drawings, wherein, by way of illustration and example, the aspects of the present invention are disclosed.

### SUMMARY OF THE INVENTION

The present invention is directed towards a method of generating nanobubbles in a liquid by creating thermal gas solubility modulation using a Thermometric Peltier-element (TPE)-based apparatus that involves altering the gas solubility of the liquid, resulting in the formation of nanobubble suspension. The present invention also provides an apparatus for the efficient and continuous generation of nanobubbles. The apparatus comprises at least two closed-loop flow channels that allow two liquid streams with different gas solubilities to pass through the channels from one end to the other. A number of metallic fins are thermally connected to one or more heat-conducting plates, wherein the metallic fins and the heat-conducting plates extend along the length of the flow channels. The heat conducting plates are further thermally connected to at least one heat pipe in connection with the Peltier elements or battery elements. Two separate gas-saturated liquid streams mix at different temperatures, resulting in the formation of nanobubbles of the dissolved gas due to the solubility difference of the liquid streams. The present invention also discloses the method of application of the nanobubbles in industrial processes such as wastewater treatment, thromboembolic disease treatment, increasing water porosity in soil, reducing corrosion and fouling in liquid pipes, and applications where highly aerated liquid is required.

### OBJECTIVES OF THE INVENTION

A primary objective of the present invention is to create nanobubbles in a liquid by creating thermal gas solubility modulation using a Thermometric Peltier-element (TPE)-based apparatus.

Another objective of the present invention is to provide an efficient, simple, and inexpensive method for the continuous generation of nanobubbles.

Yet another objective of the present invention is to prepare nanobubbles that have a higher surface-to-volume ratio and a negligible rising velocity in liquid, making them ideal candidates for the transfer of gas in the bulk liquid.

### BRIEF DESCRIPTION OF DRAWINGS

The present invention will be easier to understand after reading the following detailed description of the currently preferred aspects of it with reference to the attached drawings. From the drawings, it will be easier to see the features, other parts, and benefits of some examples of how the invention can be used.

FIG. 1 illustrates the front schematic view of a Thermoelectric Peltier-element (TPE)-based apparatus for the generation of nanobubbles.

FIG. 2 illustrates a side schematic view of a Thermoelectric Peltier-element (TPE)-based apparatus for the production of nanobubbles.

FIG. 3 illustrates the top schematic view of a Thermoelectric Peltier-element (TPE)-based apparatus for the generation of nanobubbles.

FIG. 4 illustrates the isometric view of a Thermoelectric Peltier-element (TPE)-based apparatus for the generation of nanobubbles.

The following table provides reference numerals for the different structural elements of the system of the present invention.

| Reference Numeral | Element |
|---|---|
| 1 | Apparatus outlet |
| 2 | Outlet inner wall |
| 3 | Cold stream outlet |
| 4 | Hot stream outlet |
| 5 | Liquid flow expander/reducer |
| 6 | Peltier-element module |
| 7 | Peltier-element contacting plate |
| 8 | Heat pipe |
| 9 | Flow channel contacting plate |
| 10 | Metallic fins |
| 11 | Flow channels |
| 12 | Channel wall |
| 13 | DC power supply unit |
| 14 | Cold stream inlet |
| 15 | Hot stream inlet |
| 16 | Inlet |

### DETAILED DESCRIPTION OF THE INVENTION

The following description describes various features and functions of the disclosed system with reference to the accompanying figures. In the figures, similar symbols identify similar components unless the context dictates otherwise. The illustrative aspects described herein are not meant to be limiting. It may be readily understood that certain aspects of the disclosed system can be arranged and combined in a wide variety of different configurations, all of which have not been contemplated herein.

Accordingly, those of ordinary skill in the art will recognize that various changes and modifications to the embodiments described herein can be made without departing from the scope of the invention. In addition, descriptions of well-known functions and constructions are omitted for clarity and conciseness.

The terms and words used in the following description are not limited to the bibliographical meanings but are merely used to enable a clear and consistent understanding of the invention. Accordingly, it should be apparent to those skilled in the art that the following description of exemplary embodiments of the present invention is provided for illustrative purposes only and not for the purpose of limiting the invention.

It is to be understood that the singular forms “a”, an,” and “the” include plural referents unless the context clearly dictates otherwise.

It should be emphasized that the term “comprises or comprises” when used in this specification is taken to specify the presence of stated features, integers, steps, or components but does not preclude the presence or addition of one or more other features, integers, steps, components, or groups thereof.

Any feature or combination of features described herein is included within the scope of the present invention provided that the features included in any such combination are not mutually inconsistent, as will be apparent from the context, this specification, and the knowledge of one of ordinary skill in the art. Additional advantages and aspects of the present invention are apparent in the following detailed description and claims.

The following non-limiting illustrations are provided for a better understanding of the invention.

The term ‘nanobubbles’ herein refers to nanoscale cavities in liquid.

A ‘Peltier element/device’ is a solid-state element made of alternate strips of N-type and P-type semiconductor material and acts as an active heat pump that transfers heat from one side to another. When a DC current is applied to the Peltier element, electrons in the N-type material gain energy and move to the P-type material, creating a flow of heat from the N-type side to the P-type side. This heat absorption causes one side of the device (the cold side) to become cooler. On the other side of the device, the P-type material receives the excess heat from the N-type material, and this heat is then expelled to the external environment, causing the other side of the device (the hot side) to become warmer. The cycle continues as long as the current is applied, and the temperature difference between the two sides will depend on the magnitude of the electric current and the efficiency of the materials used in the Peltier device.

The phrase ‘thermal shock mixing’ herein refers to deviations in the properties of gas-saturated liquid streams. When two liquids with significant temperature differences are mixed together, the result is similar to thermal shock. Thermal shock occurs when the temperature of a system changes dramatically in a short period of time.

Accordingly, the present invention relates to a novel nanobubble liquid suspension generation apparatus or system for the generation of nanobubbles. The present invention provides an easy and effective way for the continuous generation of nanobubbles in bulk liquid, wherein two streams of liquid are mixed at different temperatures, and nanobubble generation is accomplished due to the solubility difference of gases in the mixed streams. The method utilizes thermal shock phenomena by mixing two streams of liquids at different temperatures. This causes a difference in the amount of gas that can be dissolved in the liquids and breaks thermodynamic equilibrium, which causes nanobubble suspensions to form.

The present invention, more specifically, provides a Thermoelectric Peltier-element (TPE)-based nanobubble generating apparatus and a method for producing nanobubbles using the TPE apparatus. The apparatus comprises at least two closed-loop flow channels that allow two liquid streams with different gas solubilities to pass through the channels from one end to the other. A series of metallic fins are thermally connected to one or more heat-conducting plates, both of which extend along the length of the flow channels. The heat conducting plates are further thermally connected to at least one heat pipe in connection with the Peltier elements or the battery elements. At least two gas-saturated liquid streams are made to pass through the channels over the metallic fins to enable heat transfer between the fins and the liquid stream. Two separate static or flowing liquid streams are exposed to different temperatures and thereafter mixed together. The TPE system destabilizes the thermodynamic equilibrium of the gas-saturated liquid and forces the dissolved gas molecules to nucleate in the form of nanobubbles. In an exemplary embodiment, the gas may be selected as O₂, and the liquid may be selected as H₂O. However, the selection of gases and liquids is not particularly limited to O₂ and H₂O, respectively. The gas may also be selected from gases like nitrogen, ozone, carbon dioxide, hydrogen, etc. The liquid and gas may be selected based on the nanobubble suspension required for a particular application.

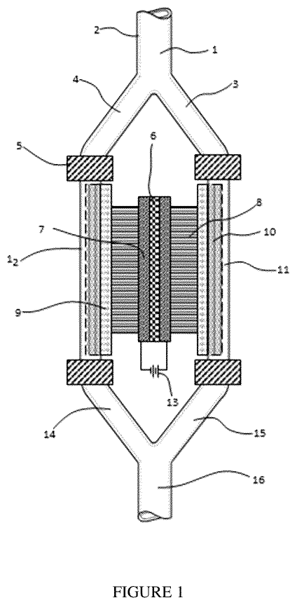

As a non-limiting example, with reference to FIGS. 1-4, a front view, a side view, a top view, and an isometric view, respectively, of the novel nanobubble liquid suspension generation apparatus for the generation of nanobubble liquid suspension are disclosed. As shown in FIG. 1, the apparatus comprises at least one flow pipe having a proximal end (16) and a distal end (1). An inlet (16) allows entry of a liquid saturated with gas (alternatively referred to as the fluid or liquid), which is used for the generation of nanobubbles, and the distal end (1) forms the exit of the flow pipe. The inlet (16) bifurcates into two flow pipes (14, 15). Each flow pipe is configured with a flow expander or a flow reducer (5) at the entry and exit of each flow pipe to regulate the flow of the gas-induced liquid into a pair of vertically connected flow channels (11). In an alternate embodiment, the two flow channels thermally connected to either side of the Peltier element are connected to two separate flow pipes. These flow pipes are then joined to their respective counterparts belonging to the other flow channels on either side of the apparatus. For instance, the inlet and outlet pipes may be on either side of the flow channels, where the two pipes containing the two liquid streams with different gas solubilities are connected.

The flow channels (11) and the flow pipe(s) (14, 15, 16) are made of but are not limited to, metals such as stainless steel, copper, brass, etc., and plastics such as Polypropylene, PVC, CPVC, Polybutylene, etc. Each flow channel is sequentially connected to a number of metallic fins (10), Flow channel contacting plate (9), Heat pipe (8), Peltier Element contacting plate (7), and Peltier-Element module (6), respectively, as shown in FIG. 1. The internal side of each flow channel (11) is thermally connected to a series of heat pipes (8) through a flow channel contact plate (9). The heat pipe may be made of any metal selected, including but not limited to Copper, aluminum, and galvanized steel. The heat pipe may be filled with any static or moving heat-conducting material. In an embodiment, the heat-conducting material may be a matrix filled with a phase-change material.

The Peltier element module (6) is enclosed within the Peltier element contact plates (7), which are further connected to a series of heat pipes (8). The power supply to the Peltier element module (6) is provided through a battery or any other power source (13) without limiting the scope of the disclosure. In an exemplary embodiment, DC electric energy is supplied to the Peltier-element module through a DC power supply unit (13). The power supply may be varied depending on the heat transfer area and/or by using a battery.

The Peltier-element module (6) is configured to heat and cool the liquid stream, which passes through flow channels (11). The space between the metallic fins (10) and the channel wall (12) is configured to provide efficient heat transfer, leading to thermal shock mixing to generate nanobubbles of the desired size. In an exemplary embodiment, the desired size of the nanobubbles required is in the range of 75-150 nm.

The Peltier-element module (6) is connected to the Peltier-element contacting plate (7), and a heat pipe (8) is placed adjacent to the contacting plate (7), followed by the flow channel contacting plate (9), which is in contact with metallic fins (10). The flow channel contacting plate (9) is configured to transfer heat into the flow channel to and fro from the Peltier-element module (6). In an embodiment, the metallic fin is made from heat-conducting metals such as, but not limited to, copper, aluminum, and the like. The two streams of liquid enter the flow channels (11) through the flow expander and reducer (5) and flow through the space between the free end of the metallic fins (10) and the channel wall (12), where the space is controlled, leading to an efficient heat transfer for causing sufficient thermal shock effect, leading to the formation of the nanobubbles. The nanobubbles generated exit through the flow expander/reducer (5) into the distal end flow pipes (3,4). The flow pipes (3,4) converge at the distal end to mix the two streams, forming nanobubbles that exit through the distal end of the flow pipe (1). This embodiment makes the apparatus/system thermally closed, resulting in negligible heat loss into the environment and making the apparatus/system thermally efficient.

The TPE apparatus of the present invention is configured to function in order to transfer heat from and to the flowing gas-saturated liquid (liquid) and the Peltier element module (6). The liquid enters the inlet pipe (16) of the apparatus, bifurcates into two streams, and travels through the liquid flow expander/reducer (5) based on the requirement. The flow expander/reducer (5) is the point where the saturated liquid enters the heat transfer unit (the part of the apparatus where the heat transfer occurs to and fro for the generation of nanobubbles). Further, the Peltier-element module (6) of the apparatus is enclosed with a Peltier-element contacting plate (7) that is in turn enclosed by a Heat pipe (8), positioned between a flow channel contacting plate (9) and the Peltier element contacting plate (7). This alignment is such that the liquid flowing through a flow channel (11) does not come into contact with the Peltier-element module (6). The flow channel and the pipes used for connecting, including the inlet and outlet pipes, are made of but are not limited to, stainless steel, polymers, plastics, and the like, without limiting the scope of the disclosure.

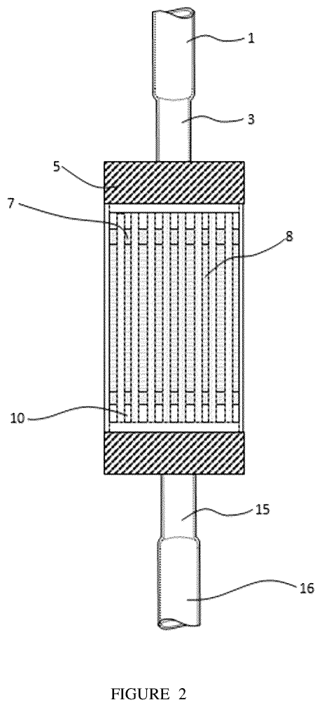

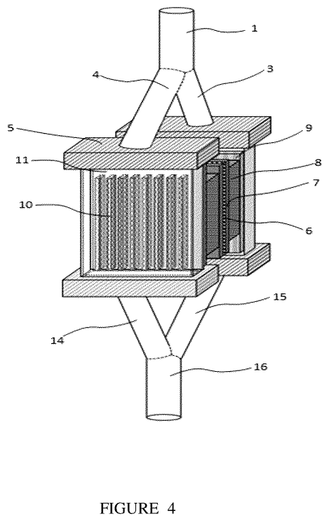

In an embodiment of the present invention, the Peltier element module (6) is thermally connected to a Peltier-element contacting plate (7) and sequentially up to Metallic fins (10) in the form of a rectangular block while remaining a thermally closed system, as shown in FIG. 2. As shown in an embodiment in FIG. 4, the PTE module (6) may be an encapsulated rectangular block with two openings at either side to be plugged into the Heat pipe (8) at both sides in a manner that makes the Peltier-element module, a thermally closed system, i.e., a cuboid containing the Peltier-element module (6), the Peltier-element contacting plate (7) opening for heat pipe (8), such that the openings may be thermally sealed if Peltier-element module (6) is connected to the Heat pipe (8).

The Peltier-element module (6) is also shaped so that liquid entering the inlet pipe (16) flows through the cold stream channel (14) and the hot stream channel (15), or vice versa. This liquid then flows through the metallic fins (10) and the liquid flow expander/reducer (5) and out in the cold stream outlet channel (3) and the hot steam outlet channel (4) into the main outlet pipe (2) to control how the machine works.

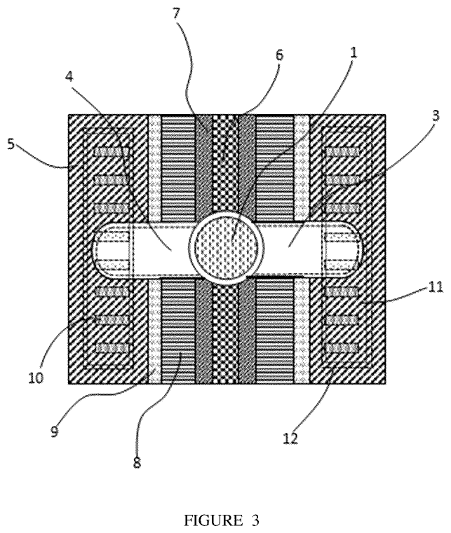

In an embodiment, the shape of the flow channel may be (11) a cylinder or a cuboid, wherein face of the flow channel contacting plate (9) transferring to and fro heat from the Peltier-element module (6) matches an inner shape of the flow channel (11), as shown in FIG. 3.

In an embodiment, the components between the flow expander or reducer (5) units on both ends of the apparatus or system may be a heat transfer unit.

In another embodiment, the apparatus or system comprises two closed flow channels (11) comprising metallic fins (10) thermally attached to a heat conducting plate (7) through a heat pipe (8), where the metallic fins (10) and the conducting plate (7) extend along the length of the flow channel while enabling the liquid streams to flow through the fins to enable the transferring of heat to and fro from the liquid streams.

In another embodiment, on either side of the apparatus connected to the apparatus or system, the inlet pipe (16) and outlet pipe (1) are positioned at either side of flow channels (11) where the two pipes containing the two liquid streams with different gas solubility are connected.

In another embodiment, the flow channels in the TPE-based apparatus comprise a tube for allowing liquid to flow from the inlet end to the outlet end, which further comprises a set of metallic fins, where these metallic fins may or may not be extendible along the tube.

In one embodiment, the flow channels of the Thermoelectric Peltier-element (TPE) based system allow liquid to flow from the inlet end to the outlet end, and the channel comprises a set of metallic fins. In another embodiment, the metallic fins extend along the channel. In yet another embodiment, the heat transfer at either side of the nanobubble generator can be induced by one or a series of electrical heaters. Also, for these embodiments, the liquid can be cooled, or gas solubility may be increased by using the addition of temperature-regulating devices such as flowing or static chillers or heaters. The cooling of the liquid in the cooling tube is achieved either by coiling the outlet tubing of a chiller unit around the cooling tube or by the contact with the cold side of the Peltier module. This is required to increase the gas solubility of the liquid on the cooling tube side.

The Peltier-element module (6) is configured to heat and cool the liquid stream, which passes through the metallic fins (10) and the channel wall (12). The space between the metallic fins (10) and the channel wall (12) is configured to provide efficient heat transfer, leading to thermal shock and mixing to generate nanobubbles. The ratio of the volume of the metallic fins (10) and the thickness and height of the flow channel (11) and the channel wall (12) determines the volume (space) between the metallic fins (10) and the channel wall (12). The lower the ratio of the metallic fins (10) and the thickness and height of the flow channel (11) and the channel wall (12), the broader the space between the metallic fins (10) and the channel wall (12). The ratio of the volume of the metallic fins (10) and the thickness and height of the flow channel (11) and the channel wall (12) is not particularly limited. In certain embodiments, the ratio may be 2:3 to 9:10. In some embodiments, the ratio may be higher than 9:10 or lower than 2:3. The large heat transfer area of the Peltier element module (6) and the large space ratio between metallic fins (10) and the channel wall (12) lead to the generation of the optimal amount of nanobubbles, that exit the apparatus through the outlet (1), which is diametrically opposite to the inlet (16). However, the smaller ratio between metallic fins (10) and the channel wall (12) is found to be beneficial for the high flow requirement of the liquid in the apparatus, and this is significant in industrial systems where the requirement of nanobubbles is on a large scale. The apparatus is configured to be altered based on the requirements of the nanobubble suspension, wherein the selection of suitable dimensions for the components that align with the desired heat transfer area is contingent upon the specific application's scope and scale.

In an embodiment, the present invention also provides a method of generation of nanobubbles comprising the steps of:
a. switching on a Peltier element module;
b. thermally heating metallic fins in thermal connection with the Peltier element module configured in a flow channel on the first side of the Peltier element module;
c. thermally cooling the metallic fins in thermal connection with Peltier element module configured in a flow channel placed on the second side of the Peltier element module;
d. passing a first stream of working fluid saturated with a gas through at least one flow channel configured with thermally heated metallic fins for heating the liquid at a temperature less than the boiling point of the working fluid,
e. passing a second stream of working fluid saturated with a gas through another flow channel configured with thermally cooled metallic fins for cooling the liquid at a temperature higher than the freezing point of the working fluid;
f. Mixing the first stream and second stream at the outlet flow pipe to generate a nanobubble liquid suspension.

In an embodiment of the present invention, the temperature difference between the two streams (i.e. stream flowing through cold stream channel and stream flowing through hot stream channel) should be reasonably large enough for optimal nanobubble generation. Higher temperature difference yields a high concentration of nanobubbles.

Difference in temperature (ΔT) between the two streams to be mixed also depends on the working liquid's freezing and boiling point. For example, if ethanol is used as a working fluid, the maximum temperature limit has to be below ethanol's boiling point, which is 68° C. To maintain a higher temperature difference, the minimum temperature has to be above −100° C., since ethanol's freezing point is −114° C.

In an exemplary embodiment, if water is incorporated in the system as the working fluid, a temperature range of 5-80 degrees Celsius is chosen based on freezing and boiling point of the water.

Nanobubbles have a higher surface-to-volume ratio and a negligible rising velocity in liquid, which makes them ideal candidates for the transfer of gas in bulk liquid. This property may be utilized in applications where high aeration of liquid is required, such as activated sludge treatment, cleaning of lakes and ponds, dye degradation in industrial effluents, etc.

The nanobubbles generated by the system of the present invention may be used to reduce fouling or corrosion in tubes or pipes used in liquid transfer. Nanobubbles may be introduced to the liquid flowing through the pipes, which may bind or cluster nanoparticles or microparticles in the flowing liquid reducing deposition of the nanoparticles in the tube or pipe, and thus helping in preventing fouling or corrosion.

Nanobubble suspensions prepared by the apparatus of the present invention may also be used for increasing the water porosity of the soil. The introduction of nanobubbles to the liquid flowing through the irrigation line causes the breakdown and/or dissolution of compounds in the soil and increases the water porosity of the soil. In exemplary embodiments, the compounds may be calcium and magnesium salts.

Nanobubble suspension prepared by the apparatus of the present invention may also be used in the treatment of thromboembolic disease in patients. In an exemplary embodiment, the nanobubbles may be introduced to the blood vessels of the patient. Alternatively, nanobubbles may be used to enable oxygen delivery to blood in the blood vessels.

Nanobubble suspension prepared by the apparatus of the present invention may also be used in wastewater treatment. Nanobubbles introduced to the wastewater may bind or oxidize biological and chemical impurities, leading to a decrease in biochemical oxygen demand (BOD) and Chemical oxygen demand (COD).

### Advantages of the Apparatus or System Over Existing Technologies

a. It is energy-efficient.
b. Chemical agent-free, as no external chemicals are used.
c. The requirement for nanobubbles is catered to both small and large-scale generation.
d. The application is across various fields, including but not limited to water treatment, agriculture, aquaculture, flotation, horticulture, medical technology, diagnostics, etc.

Having described preferred embodiments of a system and method (which are intended to be illustrative and not limiting), it is noted that modifications and variations can be made by persons skilled in the art in light of the above teachings. Therefore, it is important to understand that modifications to the specific embodiments disclosed are possible as long as they stay within the boundaries of the invention's scope and spirit, as stated in the appended claims. Having thus described aspects of the invention with the details and particularity required by the patent laws, what is claimed and desired to be protected by a Letters Patent is set forth in the appended claims.

What is claimed is:

1. A system for generating a nanobubble liquid suspension comprising:
a flow pipe inlet (16) for the inflow of the gas-saturated liquid, and a flow pipe outlet (1) for the outflow of nanobubble liquid suspension; wherein
the flow pipe inlet (16) bifurcating into a cold stream flow pipe (14) and a hot stream flow pipe (15),
the flow pipe outlet (1) is a convergent pipe, formed by converging a cold stream outlet flow pipe (3) and a hot stream outlet flow pipe (15),
at least two flow channels (11) for receiving the inlet flow streams from inlet flow pipes (14, 15);
a series of flow expander or reducer (5) configured on either side of each flow channel;
a heat transfer unit configured in the flow channels (11), the heat transfer unit comprising:
a. a series of conducting metallic fins (10) connected to a channel wall (12), wherein space between the channel wall (12) and the series of metallic fins (10) forms the flow channel (11);
b. a heat pipe (8) thermally connected to each flow channel (11) through a flow channel contacting plate (9); and
c. a Peltier element module (6) thermally connected to a number of heat pipes (8) through a number of Peltier-element contacting plates (7);
d. a power supply source (13) connected to one side of the Peltier element module (6).
a cold stream outlet (3) and a hot stream outlet (4) to exit the nanobubbles generated by the heating and cooling of the saturated gas-liquid stream.

2. The system of claim 1, wherein the series of metallic fins (10) and the heat conducting plates (7) extend along the length of the flow channels.

3. The system of claim 1, wherein the ratio of the volume of the metallic fins (10) and the thickness and height of the flow channel (11) and the channel wall (12) is in the range of 2:3 to 9:10.

4. The system of claim 1, wherein the length of the flow area of the inlet of the system (16) and the outlet of the system (1) is more than three times smaller than the length of the flow area within the flow channel (11).

5. The system of claim 1, wherein the liquid is selected as water but is not limited to water.

6. The system, as claimed in claim 1, wherein the gas is selected as but not limited to O₂, N₂, CO₂, O₃, H₂, etc.

7. The system of claim 1, wherein the flow channel (11) may be cylinder or cuboid and the flow channel contacting plate (9) matches the inner shape of the flow channel (11). The system of claim 1, wherein the temperature difference between the hot stream flow channel and the cold stream flow channel is in the range of temperature between the freezing point and the boiling point of the working liquid flowing through the system.

8. The system of claim 1, wherein the temperature difference between the hot stream flow channel and the cold stream flow channel of a water stream is in the range of 5° C. to 80° C.

9. The system of claim 1, wherein the number of metallic fins is in the range of 15 to 40 for larger flow rates and higher heat loads.

10. A method for generating a nanobubble liquid suspension comprising:
a. switching on a Peltier element module (6);
b. thermally heating metallic fins in thermal connection with the Peltier element module (6) configured in a flow channel on the first side of the Peltier element module (6);
c. thermally cooling the metallic fins in thermal connection with Peltier element module (6) configured in a flow channel placed on the second side of the Peltier element module (6);
d. passing a first stream of working fluid saturated with a gas through at least one flow channel configured with thermally heated metallic fins for heating the liquid at a temperature less than the boiling point of the working fluid,
e. passing a second stream of working fluid saturated with a gas through another flow channel configured with thermally cooled metallic fins for cooling the liquid at a temperature higher than the freezing point of the working fluid;
f. mixing the first stream and second stream at the outlet flow pipe to generate a nanobubble liquid suspension.
